(19) United States
(12) Patent Application Publication
(10) Pub. No.: US 2013/0088490 A1
(43) Pub. Date: Apr. 11, 2013

(54) METHOD FOR EYEWEAR FITTING, RECOMMENDATION, AND CUSTOMIZATION USING COLLISION DETECTION

(71) Applicants: Aaron Rasmussen, Santa Monica, CA (US); Adrienne Rasmussen, Martinez, CA (US); Eric Tong, Los Angeles, CA (US)

(72) Inventors: Aaron Rasmussen, Santa Monica, CA (US); Adrienne Rasmussen, Martinez, CA (US); Eric Tong, Los Angeles, CA (US)

(21) Appl. No.: 13/435,337

(22) Filed: Mar. 30, 2012

Related U.S. Application Data
(60) Provisional application No. 61/471,209, filed on Apr. 4, 2011.

(51) Int. Cl. G06T 17/00

(52) U.S. Cl. CPC G06T 17/00
USPC 345/421

(57) ABSTRACT

A system and method is presented for virtually fitting clothing, jewelry, hats, or eyewear frames utilizing 3D scans of a user's face and/or body. The system and method include inputting a 3D scan of a user's face and a 3D model of the item into the software. The 3D image of the item to be fitted is placed on the face or body image resulting from the 3D scan and is iteratively moved until collision is detected between the 3D model of the item and the 3D model of the face or body. A recommendation engine can be used to recommend different items to the user based on the virtual fit. Eyewear frames may be recommended based on testing each model to determine if temple pieces are long enough to get over the ear and if flex is too great or too small.

### CROSS REFERENCE TO RELATED APPLICATIONS

This patent application claims priority from U.S. Provisional Application 61/471,209 titled “Method for Eyewear Fitting, Recommendation, and Customization Using Collision Detection” which is herein incorporated by reference.

### FIELD OF THE INVENTION

The present invention relates generally to virtual fitting of eyewear, clothing, headcovers, sports performance goggles, hats, jewelry, and other items worn by individuals with the aid of electronic devices.

### BACKGROUND

With the proliferation of user-generated, product review websites such as Yelp™, Amazon™, Zappos™ and others, the voice of the customer (VOC) continues to rise and consumers are becoming increasingly more demanding of their products and services they pay for. With respect to the optical and garments industry, there has been little innovation in the overall shopping experience. Consumers continue to be challenged with the daunting task of deciding which eyewear frames or clothing to purchase when faced with hundreds, and sometimes thousands, of choices and styles from which to choose. Consumers are demanding and searching for innovative solutions to improve their overall user experience and assurances that the final product meets both their style and comfort criteria.

In the field of eyewear, on average, the consumer spends over 30 minutes in narrowing his choices and making a final decision on his frame of choice. As evidenced by market research done by the inventors and confirmed in numerous recent articles, the consumer often feels overwhelmed by the available options and often looks to a friend or family member for their advice or, most often, seeks the consultative opinion of the optician. Additionally, there are significant ethnic variances that come into play with respect to facial features such as head shape, nose bridge, cheek bone structure, and other key factors that compound the consumers experience further. This process typically results in the consumer trying on multiple frames before finding a frame that meets both their style and comfort fit criteria.

Furthermore, as commerce continues to move online, there is an increasing need for an accurate way for users to determine if a pair of eyewear frames, clothing or other garments fits them and looks good without ever having to try them on. Because of the vast selection of eyewear frames available to consumers and the overwhelming feeling of selecting a frame both online and in traditional brick and mortar retail, a recommendation engine is necessary to narrow the search.

At present, there is no commercially-available software for virtually trying on and accurately assessing fit of eyewear frames or other items to be worn by the customer. Prior art has tried to address the problem using measurements of the user's face. There are a number of associated problems with these approaches. Some require hand measurement of the user's face while others attempt automated determination of key features on the face. Because the measurement style requires very accurate measurements in all parameters each time, there is a very small margin for error in automatically acquiring measurements. Manually acquiring measurements is slow and also allows for considerable human error. Also, measurements alone do not address all the aspects of fit since a significant component of fit relates to the curvatures of the nose bridge and cheeks.

Due to differences in physiological and facial structure across the human population, it is not always possible to find eyewear frames in a desired style to fit a user's face. What is required is a system and method of virtual try-on that will also allow the user to dynamically customize the eyewear frames, clothing, hats, and other items to be worn by the customer. For example, the user can use the software to lengthen or shorten or broaden an item before it is purchased.

### BRIEF SUMMARY OF THE INVENTION

This summary is provided to introduce (in a simplified form) a selection of concepts that are further described below in the Detailed Description. This summary is not intended to identify key features of the claimed subject matter, nor is it intended to be used as an aid in determining the scope of the claimed subject matter.

The present invention is a 3D virtual try-on and recommendation engine that brings much needed innovation to the industry and significantly improves the overall user experience. The present invention provides a new method for virtually determining eyewear and clothing fit, and performing recommendations. This is accomplished by using iterative collision detection between a 3d model of the user's face/head or body and a 3d model of the desired pair of eyewear frames or other item to be worn by the user. In an embodiment of the present invention, the collision detection is primarily performed between the front piece of the eyewear frames and the nose/eyebrow/cheek area of the face, and the temple pieces. The frames themselves are first roughly aligned to the ears on the face using a generic eyeglass model. The glasses are then rotated down on to the nose until a collision is detected. Once in place, the temple pieces are either flexed based on material, or rotated at the hinges until they collide with the sides of the head. To determine recommendations, this process is performed for each model in the library to determine desirability based on nose (or an undesirable cheek collision) or too much or too little flex or rotation in the temple pieces.

If the user is dissatisfied with the available choices, or wants more control over their eyewear, he may enter customization mode, where a number of parameters can be altered on the glasses for better fit. These are: temple piece length, front piece width, front piece height, front piece angle, bridge width, nose pad length, nose pad angle, and nose pad width. As the user alters these variables, the iterative process is repeated to visually show the user what the glasses will look like aesthetically, as well as to calculate fit. The software can then iteratively adjust the variables to recommend a customized pair of glasses with optimal fit. Furthermore, the software will allow users to customize non-form fitting variables such as colors, materials, thickness, engraving, and other aesthetic variables.

In an embodiment of the present invention, the customer's face is scanned in an optometrist's office and the 3D image data is imported into the computer system which is controlled by the operator (optician) and viewed by the customer. The software has the capability of determining quality of fit using collision detection, physics, and pressure. The system then prompts the user if they're shopping for prescription frames or sunglasses and then the consumer can select their choice of style such as “Aviator” or “Horn-rimmed” as well as brand and color preferences. The software uses the calculated fit and stated style preferences to develop a set of recommended frames for the customer. The customer can then virtually try on every pair in the recommended set. The user actually is able to see what the frames will look like on his face because the software will overlay the selected frames on a 3D model of the face with texture mapping, providing a very realistic image which can be rotated and viewed from many angles. Upon narrowing down the choices, the user will then be able to physically try them on in the store. The resulting experience is much more rewarding as the intimidation of the excessively large inventory is diminished, the overall time to make a decision is expected to be reduced, and the user experience is more memorable creating a more loyal relationship with the customer. The eyewear retailer may also use this technology as a tool to create highly targeted customized marketing materials that can be sent to the customer. The marketing material will differ from other available options because it will show the customer himself or herself wearing the advertised frames or articles of clothing.

### BRIEF DESCRIPTION OF THE DRAWINGS

Preferred and Alternative examples of the present invention are described in detail below with reference to the following Figure drawings:

FIG. 1 illustrates a block diagram of stand alone system in accordance with an embodiment of the present invention operable to aid a user in virtually trying on an item.

FIG. 2 illustrates a block diagram of a networked system in accordance with an embodiment of the present invention operable to aid a user in virtually trying on an item.

FIG. 3 illustrates a flowchart for virtually trying on an item in accordance with an embodiment of the present invention.

FIG. 4 illustrates a model of a user's head and a model of eyewear including important points in the models in accordance with an embodiment of the present invention.

FIG. 5 illustrates a model of eyewear including important points in the model in accordance with an embodiment of the present invention.

FIG. 6 illustrates a flowchart for virtually trying on eyewear in accordance with an embodiment of the present invention.

FIG. 7 illustrates data tables used to store important consumer and product information in accordance with an embodiment of the present invention.

FIG. 8 illustrates a user interface for the virtual try-on system in accordance with an embodiment of the present invention.

### DETAILED DESCRIPTION OF THE INVENTION

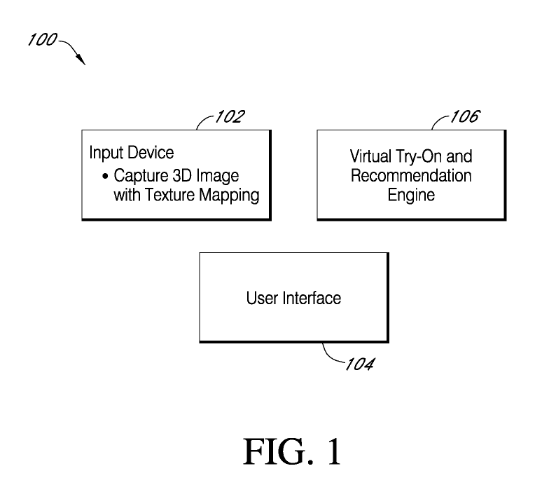

In accordance with an exemplary embodiment of the present invention, FIG. 1 illustrates a virtual try-on system 100 comprised of various subcomponents. The subcomponents include an input device 102, a user interface 104, and a virtual try-on and recommendation system 106. The input device 102 may be a camera or a 3D scanner. In an embodiment of the present invention, the input device 102 may be any device that can generate a 3D image of a user. The system of FIG. 1 also includes a user interface 104. The user interface 104 allows the user to interact with system. In an embodiment of the present invention, the user interface 104 includes a screen, a keyboard, and one or more pointing or selecting devices such as a mouse, trackball, or track pad. In an embodiment of the present invention, the user interface may include a game controller or may be able to accept voice commands. In an embodiment of the present invention, the user interface 104 may also include a touch screen.

The third subcomponent shown of FIG. 1 is the Virtual Try-on and Recommendation Engine 106. The Virtual Try-on and Recommendation Engine 106 takes data inputted by the user and captured by the input device 102 and processes it to model how an item will look on a user. This model is then presented to the user through the user interface 104. A key feature of the Virtual Try-on and Recommendation Engine 106 is that the software is not tied to any specific devices. In embodiments of the present invention, the Virtual Try-on and Recommendation Engine 106 may be used with a 3D scanner and is capable of processing a 3D image from any source (as long as the file is an appropriate format.) The Virtual Try-on and Recommendation Engine 106 is operable with lower resolution or different devices such as a webcam or the Kinect™ (developed by Microsoft™ for the X Box™) for at-home scanning The Virtual Try-on and Recommendation Engine 106 may be implemented using a computer or other electronic device. The implementation may include a microprocessor or microcontroller such as those designed or manufactured by Intel™, AMD™, IBM™, or Apple™. The computer or electronic may use either the Harvard or the Princeton architectures and the microprocessor may be based on either the x86 instruction set, a RISC instruction set, or an equivalent instruction set.

The system illustrated in FIG. 1 may be implemented in specialized hardware as a kiosk for use in a department store, retailer or boutique. In an embodiment of the present invention, the system of FIG. 1 may be implemented on a desktop or laptop computer, tablet device, or smart phone. In embodiment of the present invention, the device used to implement the invention may be used solely for the invention. In other embodiments of the present invention, the device may have other uses beyond the present invention. In an embodiment of the present invention, the invention may be implemented on a gaming console such as an XBOX™, Wii™, or Playstation™. The user interacts with the invention using the console's controllers and images displayed on a connected television, monitor, or display. A camera or peripheral including a camera or other input device is used to generate the 3D scan of the user.

In an embodiment of the present invention, the Kinect™ for XBOX™ may be used as a platform for a home shopping interface utilizing the present invention. The home shopping interface deployed through the Kinect™ is used as a platform for online clothing sales and virtual try-on. In embodiments of the present invention, the system utilizes a standard webcam to obtain an approximated 3D model of the face or body or both. In an embodiment of the present invention, all subcomponents of the virtual try-on system are housed in the same hardware. In an alternative embodiment of the present invention, one or more subcomponents are peripheral to one or another. This allows the virtual try-on system to use “off the shelf” components. Webcams, digital cameras, camcorders and other devices may be used as the input device. The user interface may use televisions, screens, monitors, projectors for display and may include joysticks, keyboards, touchscreens, mice, trackballs, remote controls, and other input devices for user input. The Virtual Try-on and Recommendation Engine may be housed in any computer, computing device, gaming systems, or electronic device that can send and receive data from the input device and user interface and process that data in accordance with the present invention.

In an embodiment of the present invention, the Virtual Try-on and Recommendation Engine may be implemented with a mesh preprocessor to accommodate for limitations in the 3d collision and physics engine. These considerations are not necessary under other implementations. The preprocessor separates the face mesh into pieces with 65,000 triangles or less, or another number of triangles depending on the 3d engine requirements. It saves the associated texture maps either in part, or with appropriate alignment coordinates pointing to a single copy of the texture maps. This separation allows models to be seamlessly imported into the 3d platform. Mesh colliders are created for key points. Separate meshes that are aligned with the main face mesh composite are created with 255 triangles or less, or another number of triangles depending on the mesh collider requirements. These may be brought in as separate models into the 3d platform. The key points the mesh colliders cover are the nose, browbone, and upper cheeks. This area is computed by finding the y-axis extent of the face mesh, which is the user's nose, and then selecting vertices within a defined rectangle that is likely to encompass approximately three inches up from the nose and all the way across the face to a depth of four inches. The preprocessor finds the x-extents of the face mesh and picks the mode of all the values (within a tolerance). The result of this process is to find the maximum width of the head without the ears. This result is used as the starting width of the glasses. This data may be stored along with any other necessary alignment data to a file. Data models and files may be placed into a new folder titled the same as the initial face mesh file with “processed” appended.

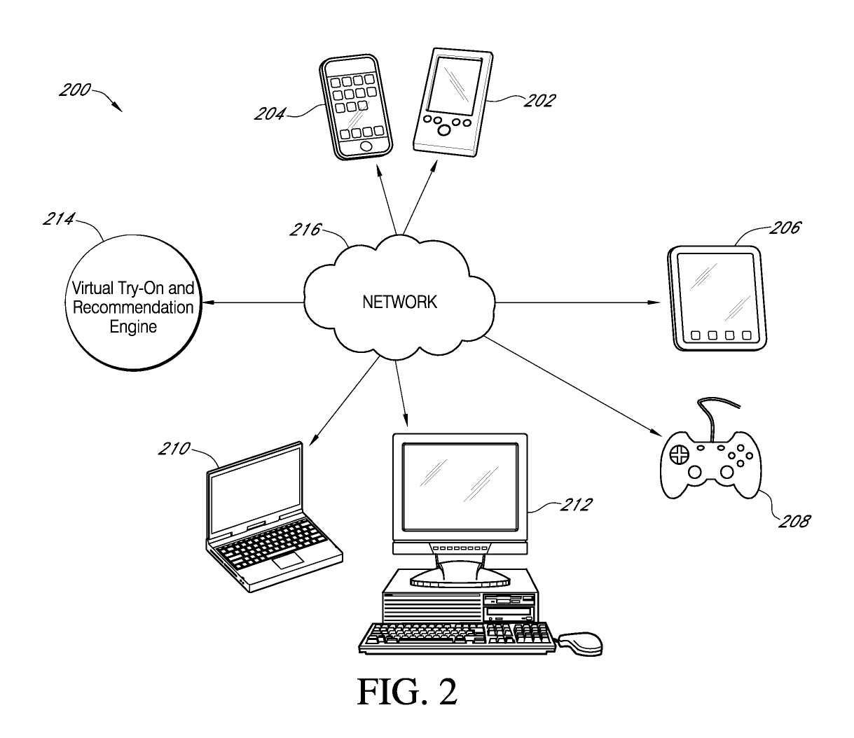

FIG. 2 illustrates a block diagram of a networked system 200 in accordance with an embodiment of the present invention operable to aid a user in virtually trying on an item. The block diagram shows one or more devices including cell phones 202 or smart phones 204, tablet computers 206, gaming systems 208, laptops 210, and desktops 212 (which are collectively called user devices), connected to the Virtual Try-on and Recommendation Engine 214 via a network 216. In an embodiment of the present invention the network 216 connecting the devices to the Virtual Try-on and Recommendation Engine 214 is the Internet. In other embodiments, this network 216 may be a proprietary network, a cellular or wireless network, a wired network (such as a LAN), or a combination of some or all of these networks. Furthermore, the some or all of these networks may be used in conjunction with the Internet to implement the present invention. In an embodiment of the present invention, the user devices provide the user interface functionality and the input device functionality previously described with regard to FIG. 1. This functionality may be provided through the user device itself or peripheral devices that work with the user device. In an embodiment of the present invention, the Virtual Try-on and Recommendation Engine 214 is implemented using a server connected to the network 216. The server may be use any computing platform available including but not limited to those using microprocessors based on the RISC or x86 instruction set and running operating systems such Windows™ or those based on Unix™ or Linux™. The Virtual Try-on and Recommendation Engine 214 may reside on one server or may be distributed over many servers or distinct computers.

In an embodiment of the present invention, the Virtual Try-on and Recommendation Engine 214 may have access to a database storing some or all of the following information: user information, item (such as eyewear, clothing, hat, jewelry, etc.) information, and pricing information. This database may be collocated on the same server with the Virtual Try-on and Recommendation Engine 214 or remote from it. The Virtual Try-on and Recommendation Engine 214 may perform all of the processing necessary to virtually model the item on the user itself or may share some or all or the processing burden with the user device. In an embodiment of the present invention, the user may access the Virtual Try-on and Recommendation Engine 214 through a webpage displayed using a browser application. The Virtual Try-on system may be its own webpage or integrated into another webpage such as an online clothing or eyewear store. In an embodiment of the present invention, the Virtual Try-on system may be implemented as a software application or applet on the user device. The software application or applet may be solely the Virtual Try-on system in accordance with the present invention or it may be integrated with other functionality such as online shopping.

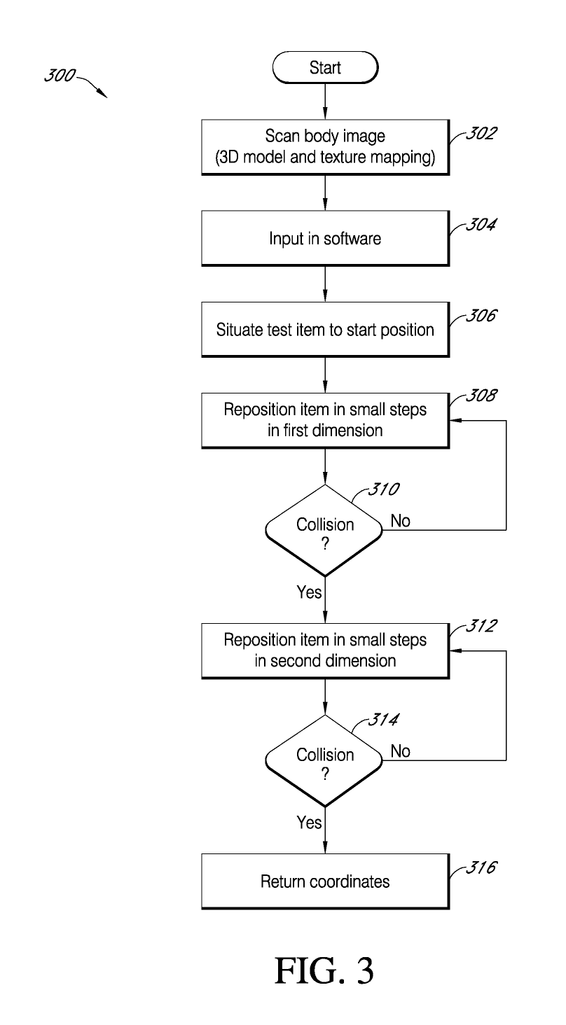

FIG. 3 illustrates a flowchart 300 for virtually trying on an item in accordance with an embodiment of the present invention. The first step is to scan the body of the user 302. A 3D model of the user's body is captured and generated. In an embodiment of the present invention, texture mapping is utilized. This model is then input into the software 304 (or system running the software) for the Virtual Try-on process to begin. The test item is then situated to a start position 306. In an embodiment of the present invention, the start position may be selected by the Software itself or the user may select or be required to select or aid in the selection of the start position. The item is then repositioned in small steps in the first dimension 308. The coordinate system utilized in the present invention may be any coordinate system used to represent 3D space. Examples of coordinate systems utilized by the present invention include but are not limited to the Cartesian coordinate system (that is the system that uses the x, y, and z axes situated at 90 degrees from each other) or the polar coordinate system. The present invention may use any dimension as the starting dimension and move on to the other dimensions in any order. Once the item is repositioned in using a small step, the Virtual Try-on system checks to see whether a collision has taken place between the model of the item and the model of the user's body 310. If no, the repositioning step is repeated. If yes, the process moves to the next step 312. Once the item is repositioned in using a small step, the Virtual Try-on system checks to see whether a collision has taken place between the model of the item and the model of the user's body 314. Once the item has been situated in all directions, the process finishes by returning the coordinates of the item 316. These coordinates can then be used to generate a view to the user of how the item would look on the user in actuality. Additionally, movement in the coordinate space may not be the only parameters of the model that are iterated until a collision is found. For clothing and other applications, the mesh itself may be deformed iteratively until the correct deformation is found. For example, a 3d pair of jeans may be slipped onto the 3d model of the user's legs such that the entire pair of jeans is iteratively stepped up onto the legs, and the deformation of the fabric is iteratively altered as collisions happen until the jeans are fully on the legs. Instead of the position of the whole object being iterated, single polygons or vertices may be transformed. This is just another manner of combining collision detection and the iterative process and applying it to model fit.

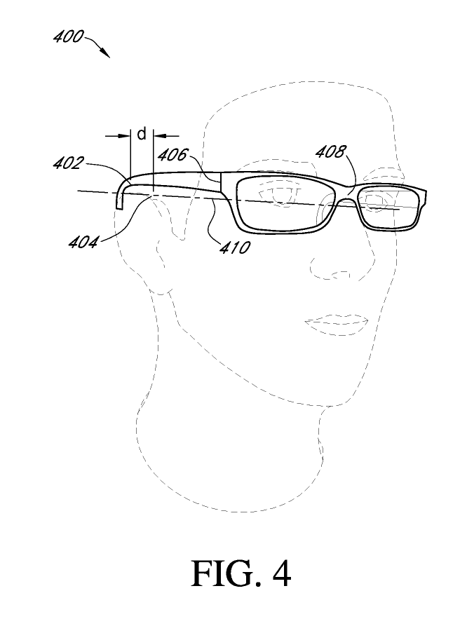

FIG. 4 illustrates a model 400 of a user's head and a model of eyewear including important points in the models in accordance with an embodiment of the present invention. To best fit the eyewear to the user's head, this embodiment of the present invention keeps track of certain data points which are stored as coordinates. These data points include the beginning of ear hook point 402, the above ear point 404, the hinge point 406, and the bridge location point 408. Another important piece of data includes the glasses rotation axis 410. Together, these pieces of data help define how the eyewear will fit on a user. By adjusting these points and keeping track, the Virtual Try-on System can model how a piece of eyewear will look on a user. While the data points shown in FIG. 4 are used in one embodiment of the present invention, they are by no means the only set of data points that may be used. All, some, or none of these data points may be used with other data points (not shown) to help fit an item such as eyewear to a user.

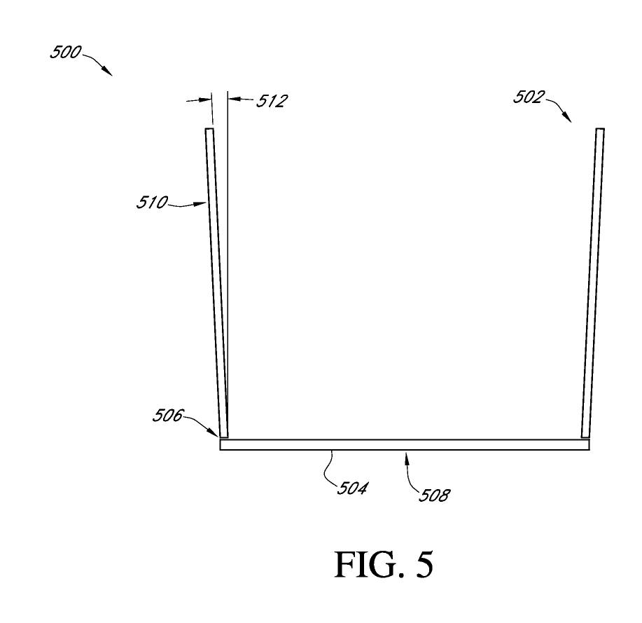

FIG. 5 illustrates a model 500 of eyewear 502 including important points in the model in accordance with an embodiment of the present invention. FIG. 5 shows a view of the eyewear 502 looking down on the eyewear 502 and without an image of the user's head. The front piece 504 of the eyewear 502 is connected to the two side pieces at the hinge point 506 (one of which is labeled in the figure). In the middle of the front piece 504 is the bridge location point 508. On the side pieces are the above ear points (one of which 510 is labeled on the figure). The flex angle 512 is also shown on the figure. This is the angle of flexure or how much the side pieces are bended away from a ninety degree angle with the front piece). While the data points shown in FIG. 5 are used in one embodiment of the present invention, they are by no means the only set of data points that may be used. All, some, or none of these data points may be used with other data points (not shown) to help fit an item such as eyewear 502 to a user

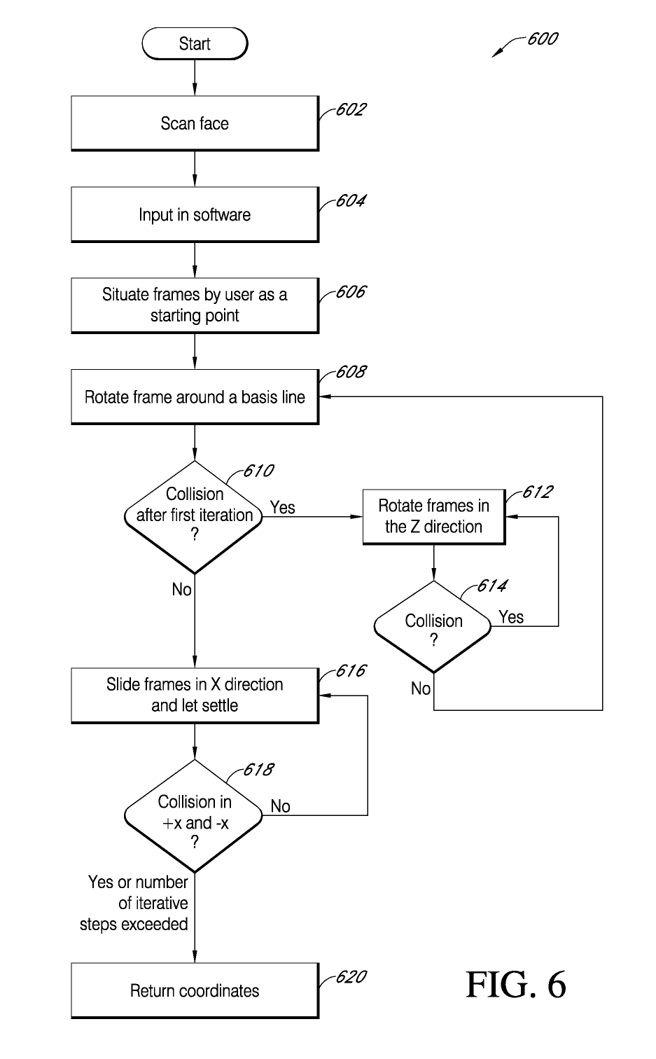

An embodiment of the present invention provides a method 600 for virtually fitting eyewear to users and providing recommendations. Utilizing the method illustrated in FIG. 6, the user can see how a variety of eyewear frames will fit on his or her face. Furthermore, in an embodiment, the software will provide them with a list of recommended frames.

The process begins by acquiring a 3D scan of the user's face 602, including phototexturing. In the preferred embodiment, scans using a 3D scanner are used at approximately forty-five degree angles. As discussed before, any 3D scanning device can be used as a scan source as long as the scan has high enough resolution. In an embodiment of the present invention, the resolution is in the <1 mm range. It is important that the scan acquire a shadowless model of the face and positioning on the ears and temples. The 3D scan of the user's face will from here on be referred to as the “face model.”

Next, the face scan is imported into the software 604, and the software loosely places a 3D model of generic eyewear frames on the face scan 606. In an embodiment of the present invention, this is done by using the nose as a locating feature. The user then uses the arrow keys to nudge the frames into position on the face scan, as well as adjust the width of the temple pieces. By allowing the user the opportunity to situate the frames near the face and adjust the width of the temple pieces, the frames are at a closer positioning start for the iterative collision process and it will be easier for the system to determine the critical above-ear points that will form the rotation axis for future eyewear frame models.

The next step of the process is described using only a single model. In embodiments of the present invention, this process may be repeated for any number of pieces of eyewear. In an embodiment of the present invention, the eyewear frame model is imported in three pieces, the left temple piece, right temple piece, and front piece (including the bridge on metal frames). Each eyewear frame model includes five pieces of metadata, the three major pieces are the location of the rotation points on each temple pieces (usually at the end of the temple piece near the front piece) and the location of the center of the bridge on the front piece. The two minor pieces of metadata are the start of the curve of the temple piece into the ear hook, and the location of the above-ear pin that will line up with the user-selected location. These locations include the x,y,z Cartesian coordinates of each point. In this particular embodiment, no vector pointing to the model's up orientation is included because all eyewear frame models will be created in the same orientation. Front pieces are oriented with a normal vector to the front of the model towards the positive y direction and the rotation so that a normal to the top of the front piece points in the positive z direction. The temple pieces are oriented so that they will be aligned such that, if connected to the front piece, the temple piece is oriented along the positive y direction, and the rotation is commensurate with the front piece to maintain model integrity.

When the model is imported, the three major metadata points are aligned with the same points on the generic model. Then the iterative process begins. The entire frame (comprised of both temple pieces and the front piece) is rotated 608 around the line created by connecting the two above-ear points set using the generic eyewear frame model until a collision is detected between the front piece and the face scan. If a collision is present on the first iteration 610, the frame is rotated up in the z direction 612 until no collision 614 is detected, then it is again lowered until a collision is detected. The goal of this step is that if the glasses start too far down on the nose, they can be rotated up until they are clear before fitting occurs. Once a collision is detected, the frame is allowed to slip along the y-axis (such that the front piece may rotate around the z-axis in a wriggling motion and the front piece appears to move back and forth in the x direction 616) as it is rotated down so it settles on the face scan's nose or another collision point 618. This move can be executed by using configured joints at the above-ear points such that the points are rigid in orientation and position, except that they can slide along the y-axis of the frame independently of one another and z-axis rotation is kept free. If the iterative attempt in either z-axis rotation direction does not create a non-collision iteration, the last iteration is considered the final resting point of the frame. The goal of this step is to allow the glasses to settle on the nose so that they are firm and the nosepads can not twist in either direction. The coordinates are returned 620.

The parameters for a model of eyewear frames is the y direction offset, the rotation angle about the connecting line (between the above-ear points) and the flex at the 2 hinge metadata points, which can be thought of as a descriptor for how well the width of the frame fits. Secondly, the two minor metadata points, the locations at which the temple pieces begin to curve down, are compared in distance, after the iterative fitting, to the above-ear points to determine if the ear hooks will be a comfortable fit.

In an embodiment of the present invention, the fit percentage is calculated out of 100% (perfect fit). The computation is a(f+d) where a is the binary value of whether a collision is on the nose (1) or anywhere else (0), f is the flex of the hinges which is calculated such that 90 degrees is equal to 100% and 15 degrees above or below that is 0% fit. This could be computed with f=1−abs ((flex_angle−90)*(1/15)). d is the distance from the intersection of the above-ear in the z direction and the line formed between the metadata points of the temple piece's ear hook start point and the hinge point, and the ear hook start point. It is scaled so that deviation outside the optimal range, 10 mm for example, will scale to 0% from 100% within 10 mm in either direction. These equations are for example only, and may be replaced by linear or exponential functions as statistical fit is improved.

In an embodiment of the present invention, a 3D scan of a user's face and a 3D model of the item into the software is inputted into the system. The 3D image of the item to be fitted is placed on the face or body image resulting from the 3D scan and is iteratively moved until collision is detected between the 3D model of the item and the 3D model of the face or body. When eyewear is fitted, a simulated gravity vector is used to push eyewear frames or the nose bridge down onto the nose until the model collides with the nose, showing accurate placement on the bridge. The flex of the temple pieces is iteratively tried to determine collision with the sides of the head. A recommendation engine can be used to recommend different items to the user based on the virtual fit. Eyewear frames may recommended based on testing each model to determine if temple pieces are long enough to get over the ear and if flex is too great or too small.

In an embodiment of the present invention, the system also provides recommendations to the user. The system performs the procedure described in FIG. 6 with every model in the inventory and returns a certain number of glasses with the highest scores. Furthermore, the eyewear frames may be filtered on metadata such as style, color, material, etc. Hair color, face shape, prescription strength, and skin tone can also be applied to the metadata to assist the recommendation engine.

If the user wishes to customize the frame, they enter customization mode in the software. In this mode, the user can use sliders, similar to those found in video games, to adjust variables on the frames without limitation such as the following: temple piece length, front piece width, front piece height, front piece angle, bridge width, nose pad length, nose pad angle, and nose pad width. In an embodiment of the present invention, the system adjusts the 3D representation of the frames by interpolating between two models of the frames. One model contains the temple piece, for example, at its shortest possible length. The next model contains the same 3D data as the first model, but modified for the temple piece's longest length. Whether polygons, NURBS, or other representations are used, interpolation between models is predicted because the number of control points on the glasses does not change. In the case of a polygon-vertex mesh representation, the vertices describing the middle part of the front piece would be close together in the short representation and far part in the long representation. By fixing the hinge point as an anchor for transformation, the two models are smoothly blended between for infinite customization. In the case of the front piece, the temple pieces are subordinated to the front piece. As the width is altered, they stay at the correct attachment points. The same principle applies to all other variables except the nose pad. In the case of a detachable nose pad support piece on a metal frame, customization is achieved by swapping out the 3D models showing the support piece, which would be subordinated to the front piece and act as one element in the iterative process. In the case of a non-detachable nose pad/support piece, such as in acetate frames, the nose piece is customized using five models of the front piece. The first model is the initial front piece position. The second model has the nose pads at maximum extension and maximum angle down at minimum width. The third has the nose pads at maximum extension and maximum angle up at minimum width. The fourth and fifth models are the same as the second and third, except at maximum width. The nose pads are adjusted by blending all five models in various strengths.

In an embodiment of the present invention, to recommend a customized frame, the software iteratively alters the variables affecting the frame for temple piece length and front piece width to maximize the fit calculation. To recommend a customized frame, the software iteratively alters the variables affecting the frame for temple piece length and front piece width to maximize a fit calculation. In an embodiment of the present invention, the adjustments made to the dimensions of the virtual frames are partially determined by collecting user feedback on actual fit of physical frames. This allows us to quantify “good fit” using qualitative customer preference data in conjunction with similar facial similarity measurements and quantitative methods described. The equation developed to measure fit in the Virtual Try-On system is used to determine the ideal measurements, angles and pressure to maximize predicted fit measurement for the customized frames.

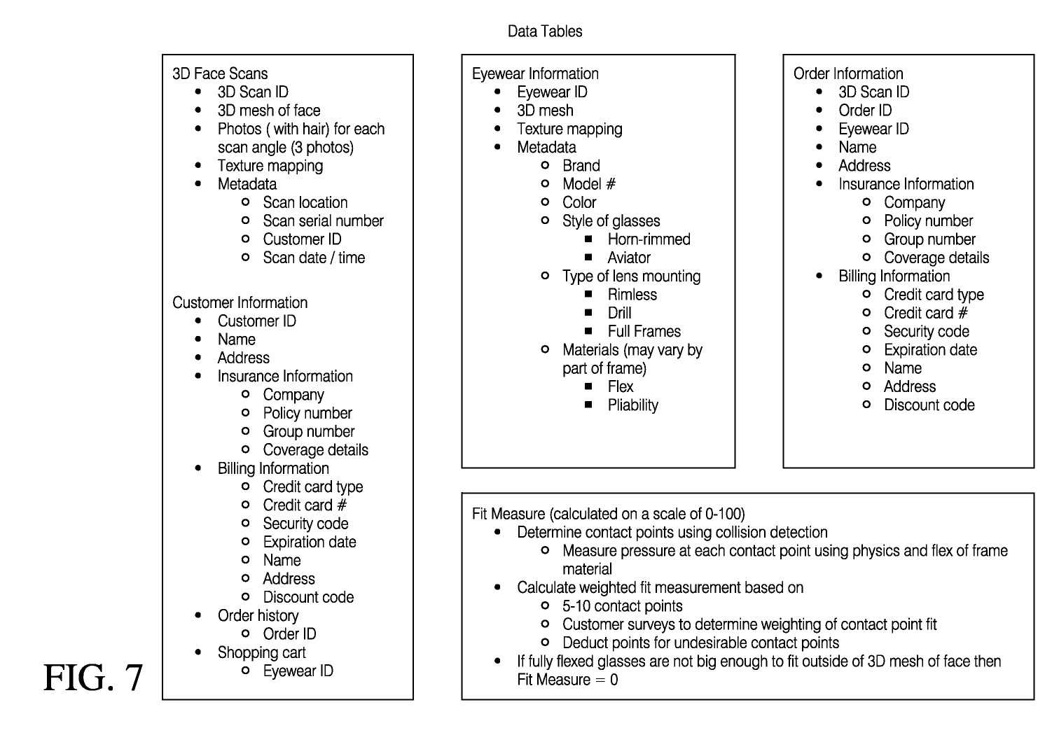

FIG. 7 illustrates data tables used to store important consumer and product information in accordance with an embodiment of the present invention.

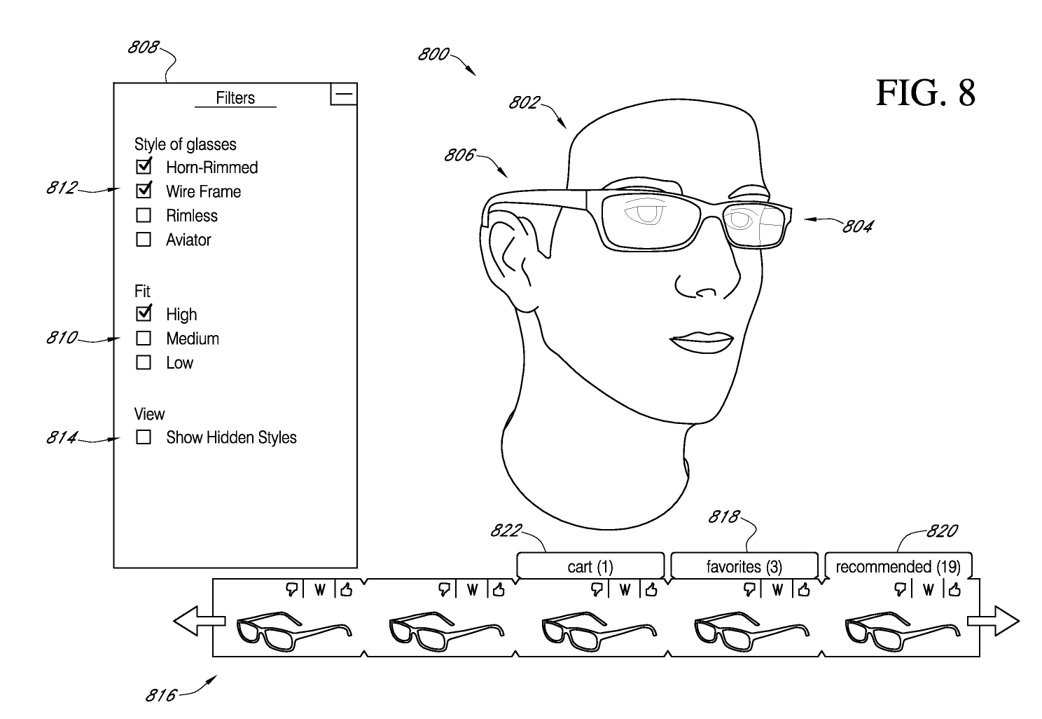

FIG. 8 illustrates a user interface 800 for the virtual try-on system in accordance with an embodiment of the present invention. The mockup user interface shows a customer's face 802 wearing generic glasses 804. In an embodiment of the present invention, instructions are shown to the user on how to adjust the glasses 804 with arrow keys (or mouse) so that a pin 806 (not actually shown on the figure) is above the ear as shown in an example picture. Furthermore, instructions may be given to show side view and allow user to move glasses so that pin (shown as an image of a pin attached to glasses at the point where frame should hit the top of ear) is in the correct position (at crease between head and top of ear) to start the fitting process. The user interface may also show a picture of where optimal pin placement is.

In an embodiment of the present invention, a “help” button may be available to the user. The user interface includes tools that allow the user to adjust width of glasses using arrow keys, mouse, or other input device. The user interface is operable to show many views of the glasses and the facial model to the user. In one embodiment of the user interface, the front view is shown and the user is allowed to adjust the width of the glasses so that temple pieces are flush against the head. The user can select any portion of the image and zoom in (and zoom out). The user interface walks the user through the process illustrated in FIG. 6. In an embodiment of the present invention, generic glasses are placed on the 3D model of the user's face. The user is prompted as to whether the placement of these glasses look good. If “yes,” the process moves forward. If no, the points are reset and the process starts over. When the user returns to pin placement screens, previous pin placement is retained.

In an embodiment of the present invention, the customer is permitted to enter his prescription. The user interface 800 shown in FIG. 8 has a selection pane 808 on left with total frames in each set. As shown, there are several fit options 810: high medium or low. There are several style options 812 such as horned, rimmed, aviator, etc. The user has the option of hiding eyewear based on styles not selected. If the “show hidden styles” button 814 is not selected, these styles will not be shown to the user.

Once a user selects a style of glasses from the selector panel 816 at the bottom of the screen, the face is shown with selected glasses. The user can select the rotate the face to gain other perspectives on how the glasses will look. The user is able to zoom in and zoom out of any portion of the facial model. In an embodiment of the present invention, there will be an “add to shopping cart” option. The selector panel at the bottom of screen show frames available. This panel also includes tabs above frames for favorites 818, recommended styles 820, and the shopping cart 822. The number of frames available in favorites or recommended may be displayed on tab in parentheses. By selecting the tabs, the user can toggle between the different sets of glasses. Arrows situated at the right and left of frames to allow the user to scroll through the set of glasses displayed in the panel. The arrows may be grayed out if the user is at the beginning or end of the selections. In FIG. 8, on each pair of frames in the panel, there is a “Thumbs Up” and “Thumbs Down” buttons. The “Thumbs Up” moves frames to favorites. The “Thumbs Down” hides frames from that point on (unless user selects “show hidden styles”). When the user clicks on the pair of frames, the user virtually tries them and the glasses are shown on the image of the customer's face. The “Recommended Tab” 820 shows available frames in the selector panel in order of fit. The “Favorites Tab” 818 shows all frames that have been marked with “Thumbs Up.” If the user selects “Thumbs Down,” the frames are removed from “Favorites.” When the user clicks “Thumbs Up,” the eyewear moves to the top of the “Favorites” queue. The selector panel also includes a “Cart” tab 822 which shows everything the user has added to the shopping cart. Instead of “Thumbs Up”/“Thumbs Down” there is an “X” next to the picture of the frames to allow user to remove frames from Cart. When frames are removed from the “Cart,” they still are shown in “Favorites” (if there were in “Favorites” before being selected for the shopping cart).

In an embodiment of the present invention, the Virtual Try-on system is operable with other programs such as social networking sites. For instance, there may be a “Share Cart with Friends” option. This option allows the user to publish his “Cart” to Facebook™. Other options include the user sending a picture of his face virtually trying on the glasses to Facebook™. The Virtual Try-on system may be extended with a Facebook™ app that allows the user's friends to vote on eyewear styles. The app may also allow friends to “like” or comment on the glasses and show the pictures along with the voting feature.

The present invention may also interface with email or instant messaging systems. These options enable a user to send glass styles, images of his face virtually trying-on different glasses, and comments to various email addresses.

The present invention may also have a “Proceed to Checkout” option or a “Save For Later” option. The “Proceed to Checkout” option takes the user to a standard shipping and payment screen. The “Save for Later” option prompts user to create a username and password.

The user interface discussed along with FIG. 8 is one of many embodiments embraced by this invention. The options along with the format of the user interface may include any options or format previously discussed along with those well-known in the art. The user interface used in embodiments of the present invention may include fixed menus, pop-up menus, and a variety of buttons, tabs, check boxes, and scroll bare. The user interface may be a website accessible using a web browser or it may be an applet or application. In the user interface, the user may be able to rotate, shift, zoom in, or zoom out of the facial image, glasses, or both. The user interface for the virtual try-on system may also be embedded in another application or website such as an application or website for an online store.

While several embodiments of the present invention have been illustrated and described herein, many changes can be made without departing from the spirit and scope of the invention. Accordingly, the scope of the invention is not limited by any disclosed embodiment. Instead, the scope of the invention should be determined from the appended claims that follow.

The embodiments of the invention in which an exclusive property or privilege is claimed are defined as follows:

1. A method for virtually trying-on an item comprising:
scanning a three dimensional image of the user's body;
iteratively moving a three dimensional image of an item selected in a first dimension in small steps towards the item until the image of the item collides with the image of the user's body;
iteratively moving the three dimensional image of the item selected in a second dimension in small steps towards the item until the image of the item collides with the image of the user's body;
iteratively moving the three dimensional image of the item selected in a third dimension in small steps towards the item until the image of the item collides with the image of the user's body; and
storing the three dimensional coordinates where the collisions took place.

2. The method of claim 1 wherein the item is a pair of eyeglasses.

3. The method of claim 2 wherein the pair of eyeglasses is a generic set of eyewear frames.

4. The method of claim 1 wherein the three dimensional image of the user is scanned by an at-home scanner.

5. The method of claim 1 further comprising providing recommendations to the user.

6. The method of claim 5 wherein the recommendations to the user are provided by using the virtual try-on method with every model in an inventory and returning a certain number of eyeglasses.

7. The method of claim 6 wherein the recommendations are filtered using metadata or based on a score.

8. A system for virtually trying-on an item comprising:
an image input device operable to produce a three dimensional scan of the user;
a user interface; and
a virtual try-on engine operable to iteratively fit a three dimensional representation of an item to the three dimensional scan of the user.

9. The system of claim 8 wherein the item is a pair of eyeglasses.

10. The system of claim 9 wherein the pair of eyeglasses is a generic set of eyewear frames.

11. The system of claim 8 wherein the three dimensional image of the user is scanned by an at-home scanner.

12. The system of claim 8 further comprising providing recommendations to the user.

13. The system of claim 12 wherein the recommendations to the user are provided by using the virtual try-on method with every model in an inventory and returning a certain number of eyeglasses.

14. The system of claim 13 wherein the recommendations are filtered using metadata or based on a score.

15. A computer-readable medium encoded with computer readable instructions, which when executed, perform a method for a method for virtually trying-on an item comprising:
scanning a three dimensional image of the user's body;
iteratively moving a three dimensional image of an item selected in a first dimension in small steps towards the item until the image of the item collides with the image of the user's body;
iteratively moving a three dimensional image of an item selected in a second dimension in small steps towards the item until the image of the item collides with the image of the user's body;
iteratively moving a three dimensional image of an item selected in a third dimension in small steps towards the item until the image of the item collides with the image of the user's body; and
storing the three dimensional coordinates where the collisions took place.

16. The computer readable medium of claim 15 wherein the item is a pair of eyeglasses.

17. The computer readable medium of claim 16 wherein the pair of eyeglasses is a generic set of eyewear frames.

18. The computer readable medium of claim 15 wherein the three dimensional image of the user is scanned by an at-home scanner.

19. The computer readable medium of claim 15 further comprising providing recommendations to the user.

20. The computer readable medium of claim 19 wherein the recommendations to the user are provided by using the virtual try-on method with every model in an inventory and returning a certain number of eyeglasses.
